(19) United States
(12) Patent Application Publication
(10) Pub. No.: US 2015/0142484 A1
(43) Pub. Date: May 21, 2015

(54) CARPOOL SERVICE PROVIDING METHOD AND CARPOOL SERVER USING THE SAME

(71) Applicant: National Taipei University of Technology, Taipei (TW)

(72) Inventors: Shih-Chia Huang, Taipei City (TW); Ming-Kai Jiau, Taipei City (TW)

(73) Assignee: National Taipei University of Technology, Taipei (TW)

(21) Appl. No.: 14/083,403

(22) Filed: Nov. 18, 2013

(51) Int. Cl. G06Q 10/06; G06Q 50/30; G01C 21/34

(52) U.S. Cl. CPC G06Q 10/063; G01C 21/3438; G06Q 50/30
USPC 705/7.11

(57) ABSTRACT

The invention discloses a carpool service providing method and a carpool server using the same. The method includes the following steps: generating a carpool population matrix according to a plurality of carpool requests received from a plurality of passengers and drivers; generating a first carpool matching result and a second carpool matching result according to the carpool population matrix; performing a routing procedure to each of the first and second segments; respectively comparing the segment fitness value of one of the second segments with the segment fitness value of the corresponding first segment and updating the second carpool matching result by replacing the one of the second segments with the corresponding first segment if the segment fitness value of the one of the second segments is worse than the segment fitness value of the corresponding first segment; updating the carpool population matrix according to the updated second carpool matching result.

### BACKGROUND

1. Field of the Invention

The invention relates to a carpool service providing method and a carpool server using the same.

2. Description of Related Art

Many countries are becoming increasingly industrialized and urbanized due to economic development and growth. As a consequence, more people are able to afford personal vehicles, leading to inevitable rises in traffic congestion in the world's major cities. Traffic congestion increases human impact on the environment and can lead to a reduction in quality of life due to many consequential negative effects such as air pollution, parking problems, noise pollution, loss of valuable time, consumption of fuel, and so on. Although public transport is capable of relieving congestion, it lacks the flexible mobility, comfort, and freedom of a private vehicle. Subsequently, private cars are the preferred method of transport for many people. Yet, the average occupancy rate in the United Kingdom is only 1.5 people per car. Carpooling is one of the best solutions to traffic congestion in that is utilizes empty seats in cars as a transportation resource. In other words, drivers share their vehicle with other persons whose routes are similar, thereby reducing the number of vehicles on roadways by increasing the rate of occupancy. Carpooling also produces auxiliary benefits such as reduced travel expense, lowered carbon emissions, and less parking hassle, among others.

Many carpool systems have been implemented in effort to benefit people and the environment. These systems can be broadly classified into two categories according to their features. The first category is the web-based system (i.e., a website). In these, the carpoolers can communicate via an online community platform. This kind of online community platform employs an integrated information platform which has the ability to accommodate both passengers who are looking for a ride and drivers who are offering their vehicles. However, web-based carpool systems do not integrate geographic information system (GIS) technology. This limits the ability of the system to match potential users via precise geographical information. Because of this, carpool users must manually search through a list of results to determine which matches are most relevant to their respective locations. The second carpool system category employs GIS technology, which allows carpoolers to request rides or to offer rides with accurate location via GIS. Because of this, these systems are able to provide route information before the trip takes place. Numerous carpool systems have been proposed by which to solve traffic congestion problems. However, several systems are relatively inflexible and require more prearrangement. For example, a passenger who wants to use one of these systems to find a carpool match must schedule a ride in advance and include many parameters such as date, time, departure location, and destination location. This is inefficient for users who require real-time carpool matching service.

In order to overcome the lack of instant access available for current carpool systems, researchers have proposed a global carpool system, such that prospective carpoolers can use their smart handheld devices to send immediate carpool requests, whereupon the global carpool system automatically matches carpool partners with similar conditions and notifies them of match results within a reasonable amount of time. In the proposed global carpool system, computational complexity increases rapidly when numerous requests are posted. The increasing number of possible combinations makes it unsuitable for use in real-time by using the exhaustive algorithm. To reduce the time required for determining match solutions and alleviating the carpool services problem, the random ratio method (RRM) is proposed. The RRM dynamically controls the random ratio parameter, and then adjusts the sampling size when searching for solutions. As a consequence, the computational time for carpool match searches is reduced. However, the RRM produces carpool match solutions of low quality. It is challenging to reduce the processing time while supplying a high-quality solution. In addition, memory usage also becomes a critical issue when numerous users are casting requests simultaneously.

That is, there are basically three issues that should be considered while solving the Carpool Services Problem (CSP): (1) High-quality solution: Travel cost should be minimized for each driver of each carpool group. (2) Low-processing time: the carpool matching process should be completed within a reasonable amount of time. (3) Low-memory requirements: the memory required for the processing of carpool matches should be as low as possible.

### SUMMARY

Accordingly, the present invention is directed to a carpool service providing method and a carpool server using the same that could not only efficiently and appropriately matching the passengers and the drivers want to use the carpool service, but also uses a small amount of memories.

A carpool service providing method is introduced herein. The method is adapted to a carpool server and includes the following steps: generating a carpool population matrix according to a plurality of carpool requests received from a plurality of passengers and drivers, wherein the carpool population matrix includes a plurality of rows, each of the rows corresponds to one of the drivers, each of the rows includes a plurality of probabilities, and each of the probabilities corresponds to one of the passengers; generating a first carpool matching result and a second carpool matching result according to the carpool population matrix, wherein the first and the second carpool matching result respectively includes a plurality of first and second segments corresponding to the drivers, and each of the segments includes a plurality of slots corresponding to some of the passengers; performing a routing procedure to each of the first and second segments, such that a segment fitness value of each of the first and second segments is maximum; respectively comparing the segment fitness value of one of the second segments with the segment fitness value of the corresponding first segment and updating the second carpool matching result by replacing the one of the second segments with the corresponding first segment if the segment fitness value of the one of the second segments is worse than the segment fitness value of the corresponding first segment; updating the carpool population matrix according to the updated second carpool matching result.

In one embodiment of the present invention, each of the probabilities is equal to a reciprocal of a number of the passengers.

In one embodiment of the present invention, the step of generating the first carpool matching result according to the carpool population matrix includes: to each of the rows, randomly selecting a number of the passengers according to the corresponding probabilities, wherein the number of the selected passengers is equal to a number of seats provided by the corresponding driver; and assembling the selected passengers of each of the rows as the first carpool matching result.

In one embodiment of the present invention, the step of performing the routing procedure includes: finding a shortest route to pick up and drop off the passengers correspond to each of the segments.

In one embodiment of the present invention, the updated second carpool matching result includes a plurality of specific segments corresponding to the drivers, and the step of updating the carpool population matrix according to the updated second carpool matching result includes: to an i-th row of the rows: finding the specific segment corresponding to the i-th row; retrieving the passengers included in the specific segment corresponding to the i-th row; adding a first parameter to the probabilities corresponding to the passengers included in the specific segment corresponding to the i-th row; and subtracting a second parameter from the probabilities not corresponding to the passengers included in the specific segment corresponding to the i-th row.

In one embodiment of the present invention, after the step of updating the carpool population matrix according to the updated second carpool matching result, the method further includes: generating a new carpool matching result according to the updated carpool population matrix, wherein the new carpool matching result included a plurality of third segments; performing the routing procedure to each of the third segments, such that the segment fitness value of each of the third segments is maximum; respectively comparing the segment fitness value of one of the specific segments with the segment fitness value of the corresponding third segment and updating the updated second carpool matching result by replacing the one of the specific segments with the corresponding third segment if the segment fitness value of the one of the specific segments is worse than the segment fitness value of the corresponding third segment; determining whether the updated second carpool matching result has been updated for a predetermined times; and if yes, allocating the passengers to the drivers according to the updated second carpool matching result.

A carpool server is introduced herein. The carpool server includes a communication unit, a storage unit and a processing unit. The communication unit is configured to receive a plurality of carpool requests from a plurality of passengers and drivers. The storage unit is configured to store a plurality of modules. The processing unit is coupled to the communication unit and the storage unit and configured to execute the modules to: generate a carpool population matrix according to a plurality of carpool requests received from a plurality of passengers and drivers, wherein the carpool population matrix includes a plurality of rows, each of the rows corresponds to one of the drivers, each of the rows includes a plurality of probabilities, and each of the probabilities corresponds to one of the passengers; generate a first carpool matching result and a second carpool matching result according to the carpool population matrix, wherein the first and the second carpool matching result respectively includes a plurality of first and second segments corresponding to the drivers, and each of the segments includes a plurality of slots corresponding to some of the passengers; perform a routing procedure to each of the first and second segments, such that a segment fitness value of each of the first and second segments is maximum; respectively compare the segment fitness value of one of the second segments with the segment fitness value of the corresponding first segment and update the second carpool matching result by replacing the one of the second segments with the corresponding first segment if the segment fitness value of the one of the second segments is worse than the segment fitness value of the corresponding first segment; and update the carpool population matrix according to the updated second carpool matching result.

In one embodiment of the present invention, each of the probabilities is equal to a reciprocal of a number of the passengers.

In one embodiment of the present invention, the processing unit is configured to: to each of the rows, randomly select a number of the passengers according to the corresponding probabilities, wherein the number of the selected passengers is equal to a number of seats provided by the corresponding driver; and assemble the selected passengers of each of the rows as the first carpool matching result.

In one embodiment of the present invention, the processing unit is configured to: find a shortest route to pick up and drop off the passengers correspond to each of the segments.

In one embodiment of the present invention, the updated second carpool matching result includes a plurality of specific segments corresponding to the drivers, and the processing unit is configured to: to an i-th row of the rows: find the specific segment corresponding to the i-th row; retrieve the passengers included in the specific segment corresponding to the i-th row; add a first parameter to the probabilities corresponding to the passengers included in the specific segment corresponding to the i-th row; and subtract a second parameter from the probabilities not corresponding to the passengers included in the specific segment corresponding to the i-th row.

In one embodiment of the present invention, the processing unit is further configured to: generate a new carpool matching result according to the updated carpool population matrix, wherein the new carpool matching result includes a plurality of third segments; perform the routing procedure to each of the third segments, such that the segment fitness value of each of the third segments is maximum; respectively compare the segment fitness value of one of the specific segments with the segment fitness value of the corresponding third segment and update the updated second carpool matching result by replacing the one of the specific segments with the corresponding third segment if the segment fitness value of the one of the specific segments is worse than the segment fitness value of the corresponding third segment; determine whether the updated second carpool matching result has been updated for a predetermined times; if yes, allocate the passengers to the drivers according to the updated second carpool matching result.

Based on the above description, the embodiments of the present invention provide a carpool service providing method and a carpool server using the same. The method proposed in the present invention could find the carpool matching result with near-optimal quality in a reasonable amount of time, such that the proposed method is applicable to real-time carpool services. Besides, since the carpool population matrix is represented by a probabilistic model instead of being characterized by many individual carpool matching results, the method proposed in the present invention only needs a small amount of memories.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a carpool system according to an exemplary embodiment of the present invention.

FIG. 2 is a flow chart illustrating the carpool service providing method according to an exemplary embodiment of the present invention.

FIG. 3A is a schematic diagram illustrating a first carpool matching result according to an exemplary embodiment of the present invention.

FIG. 3B is a detailed illustration of the first carpool matching result illustrated in FIG. 3A.

FIG. 4 is a schematic diagram illustrating the routing procedure according to an exemplary embodiment of the present invention.

FIG. 5 is a schematic diagram illustrating the mechanism of updating the second carpool matching result according to an exemplary embodiment of the present invention.

FIG. 6 is a schematic diagram illustrating the mechanism for updating the carpool population matrix.

### DETAILED DESCRIPTION OF DISCLOSED EMBODIMENTS

Some embodiments of the present application will now be described more fully hereinafter with reference to the accompanying drawings, in which some, but not all embodiments of the application are shown. Indeed, various embodiments of the application may be embodied in many different forms and should not be construed as limited to the embodiments set forth herein; rather, these embodiments are provided so that this disclosure will satisfy applicable legal requirements. Like reference numerals refer to like elements throughout.

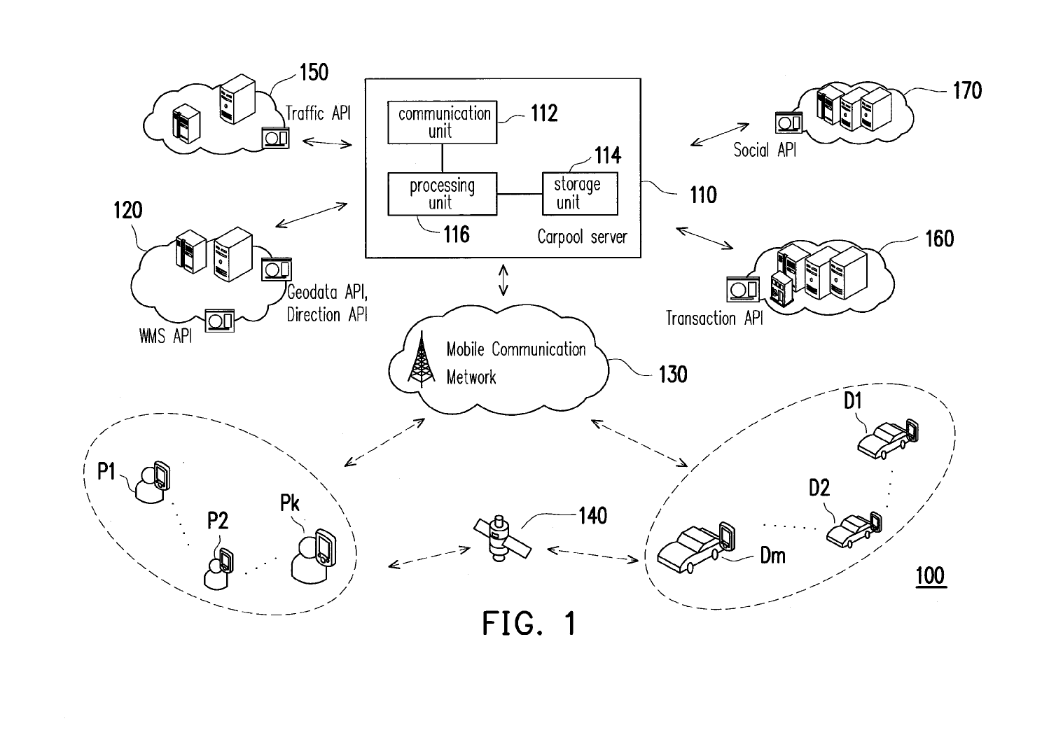

FIG. 1 is a schematic diagram illustrating a carpool system according to an exemplary embodiment of the present invention. In the present embodiment, the carpool system 100 may include a carpool server 110, an open GIS provider 120, a mobile communication network 130, a GPS satellite 140, a traffic monitor 150, a transaction service banker 160, a reputation data provider 170, passengers P1-Pk and drivers D1-Dm (k and m are positive integers).

The carpool server 110 may include a communication unit 112, a storage unit 114 and a processing unit 116. The communication unit 112 can be configured for connecting to the mobile communication network 130. For example, the communication unit 112 establishes a connection to a telecommunication station for linking the carpool server 110 to the Internet. The mobile communication network 130 can be based on 2G mobile communication technology, 3G mobile communication technology, 3.5G mobile communication technology, 4G mobile communication technology or the like. For example, the mobile communication network can be configured based on General Packet Radio Service (GPRS), Code Division Multiple Access (CDMA), High Speed Downlink Packet Access (HSDPA) or other equivalent mobile network technology. In the embodiment, communication unit 112 is not limited to adopt a specific mobile network technology.

The storage unit 114 is one or a combination of a stationary or mobile random access memory (RAM), read-only memory (ROM), flash memory, hard disk, or any other similar device, and which records a plurality of modules that can be executed by the processing units 116. These modules can be loaded into the processing unit 116 to execute a carpool service providing method.

The processing unit 116 is one or a combination of a central processing unit (CPU), a programmable general- or specific-purpose microprocessor, a digital signal processor (DSP), a programmable controller, application specific integrated circuits (ASIC), a programmable logic device (PLD), or any other similar device. The processing unit 116 is coupled to the communication unit 112 and the storage unit 114. The processing unit 116 may access and execute the modules recorded in the storage unit 114 to execute a carpool service providing method proposed in the present invention, which would be introduced later.

When the passengers P1-Pk want to ask for the carpool service provided by the carpool server 110, the passengers P1-Pk may send carpool requests to the carpool server 110 through the mobile communication network 130 by operating, for example, a carpool application installed in electronic apparatus such as smartphones, tablet, personal digital assistant (PDA) or the like. On the other hand, when the drivers D1-Dm (illustrated as cars) want to chauffeur passengers (i.e., share or provide seats to passengers), the drivers D1-Dm may also send carpool requests to the carpool server 110 through the mobile communication network 130 by operating the aforementioned carpool application.

As shown in FIG. 1, the carpool server 110 may be connected to the traffic monitor 150, the transaction service banker 160 and the reputation data provider 170.

The carpool server 110 may retrieve the real-time traffic or roadway conditions monitored by the traffic monitor 150 and accordingly adjusting the route assigning to the drivers asking for the carpool services for avoiding, for example, traffic congestions.

The transaction services banker 160 may be configured to charge the passengers who have used the carpool services or pay the drivers who have chauffeured passengers.

The reputation data provider 170 may include some social network servers, and hence the reputation data provider 170 may provide personal information of the user (e.g., a passenger or a driver), such as the number of contacts, written posts of the user. With the personal information of the user, the carpool server 110 may evaluate this user. Specifically, the carpool server 110 may simultaneously consider, for example, the number of contacts, written posts of the user and accordingly transform to a credit score of the user. In some embodiments, the carpool server 110 may adaptively adjust the credit score of the user. For example, if the user is punctual, the carpool server 110 may increase the credit score of the user. On the other hand, if the user is not punctual, the carpool server 110 may decrease the credit score of the user.

The aforementioned entities of the carpool system 100 may communicate with each others through corresponding application interfaces (API) as shown in FIG. 1.

In one embodiment, the passengers want to ask for the carpool service may register to the carpool server 110, and the carpool server 110 may assign passenger identifications to these passengers. Similarly, the drivers want to share seats may also register to the carpool server 110, and the carpool server 110 may assign driver identification to these drivers.

For facilitating the carpool service, the carpool request may include information fields such as a category of the requesting user, the user identification, the current location of the user, the destination of the user and the request number of seats. Specifically, the category of the requesting user may be configured to specifying whether the user requesting for the carpool service is a passenger or a driver. The user identification may be the passenger identification or the driver identification of the user requesting for the carpool service.

In some embodiments, the user (e.g., a passenger or a driver) may use the aforementioned electronic apparatuses to retrieve his/her current location (or coordinate) from the GPS satellite 140, and then forward his/her current location (i.e., the aforementioned information field of “the current location of the user”) to the carpool server 110 when sending the carpool request. Furthermore, the user may access the map (such as an online map) provided by the open GIS provider 120 and indicate his/her destination, and this information may be forwarded to the carpool server 110 as the aforementioned information field “the destination of the user.” The request number of seats may be the needed seats of the user if the user is a passenger, or the provided seats of the user if the user is a driver.

In one embodiment, the information fields included in a carpool request may be implemented as corresponding fields displayed in a user interface of the carpool application for the user to easily enter. Under this situation, the carpool application may integrate the information entered by the user as the carpool request and accordingly forward to the carpool server 110.

With various carpool requests from the passengers and the drivers, the carpool server 110 of the present embodiment may perform the following carpool service providing method to efficiently match the passengers with the drivers, such that the segment fitness value corresponding to each of the drivers is maximum. In some embodiments, the segment fitness value of a segment is negatively related to its travel cost. Detailed description would be provided hereinafter.

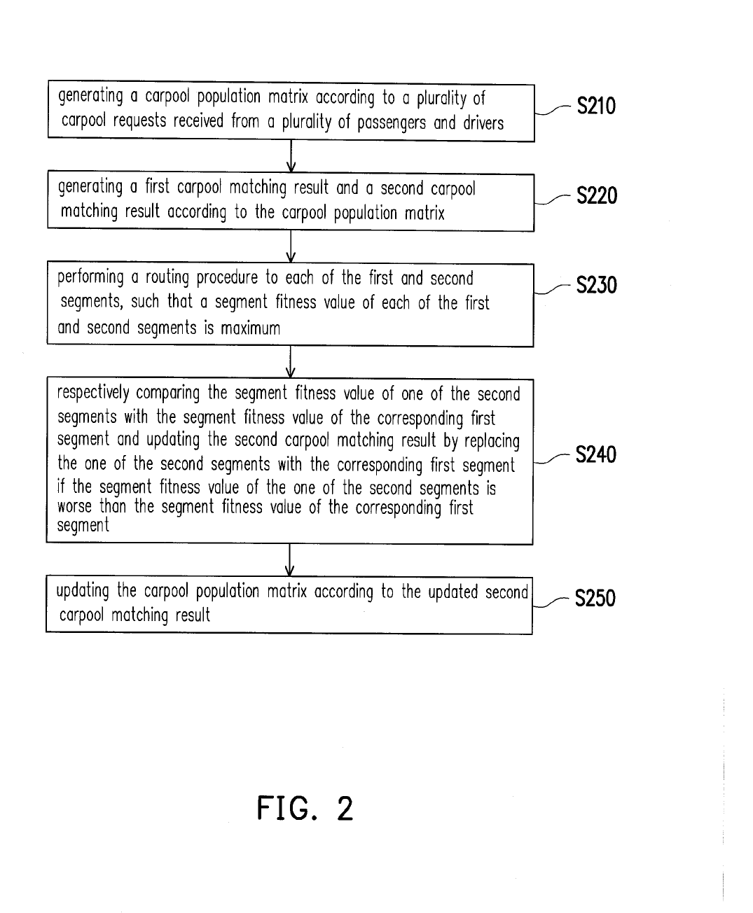

FIG. 2 is a flow chart illustrating the carpool service providing method according to an exemplary embodiment of the present invention. The method proposed in the present embodiment may be executed by the processing unit 116 of the carpool server 110 of FIG. 1, and the details of FIG. 2 would be discussed with references to FIG. 1.

In step S210, the processing unit 116 of the carpool server 110 may generate a carpool population matrix according to a plurality of carpool requests received from a plurality of passengers and drivers. The carpool population matrix may include a plurality of rows. Each of the rows may correspond to one of the drivers. Each of the rows may include a plurality of probabilities. Each of the probabilities may correspond to one of the passengers.

In one embodiment, the carpool population matrix could be represented by:

$${P}_{M} = [ \begin{matrix}{P}_{V}^{1} \\ {P}_{V}^{2} \\ ⋮ \\ {P}_{V}^{m}\end{matrix} ] = [ \begin{matrix}{P}_{E}^{11} & {P}_{E}^{12} & ⋯ & {P}_{E}^{1 k} \\ {P}_{E}^{21} & {P}_{E}^{22} & ⋯ & {P}_{E}^{2 k} \\ ⋮ & ⋮ & ⋱ & ⋮ \\ {P}_{E}^{m 1} & {P}_{E}^{m 2} & ⋯ & {P}_{E}^{m k}\end{matrix} ]$$

, where P_{M} is the carpool population matrix, which includes rows P_{V}¹−P_{V}^{m}. In the present embodiment, the elements included in the carpool population matrix may respectively represent a probability for a certain passenger being allocated to a certain driver. For example, P_{E}¹¹−P_{E}^{1k} may be regarded as the probabilities for the passenger P1-Pk to be allocated to the driver D1. For another example, P_{E}^{m1}−P_{E}^{mk} may be regarded as the probabilities for the passenger P1-Pk to be allocated to the driver Dm. From another point of view, the i-th row of the carpool population matrix corresponds to the driver Di. In some embodiments, each of the probabilities could be initialized to be equal to a reciprocal of a number of the passengers, i.e., 1/k, but the invention is not limited thereto.

In step S220, the processing unit 116 of the carpool server 110 may generate a first carpool matching result and a second carpool matching result according to the carpool population matrix.

Specifically, to each of the rows, the processing unit 116 may randomly select a number of the passengers according to the corresponding probabilities, wherein the number of the selected passengers is equal to a number of seats provided by the corresponding driver.

Take the 1^{st} row (which corresponds to the driver D1) of the carpool population matrix as an example. Assuming the driver D1 wants to provide three seats for chauffeuring passengers, the processing unit 116 may randomly select three of the passengers P1-Pk according to their corresponding probabilities (i.e., P_{E}²¹−P_{E}^{2k}). For example, if P_{E}^{1k} is equal to 1/k, this represents that the probability of the passenger Pk being selected by the processing unit 116 is 1/k.

Take the 2^{nd} row (which corresponds to the driver D2) of the carpool population matrix as an example. Assuming the driver D2 wants to provide two seats for chauffeuring passengers, the processing unit 116 may randomly select two of the passengers P1-Pk according to their corresponding probabilities (i.e., P_{E}²¹−P_{E}^{2k}).

To the rest of the rows (i.e., the 3^{rd} row to the m^{th} row), the processing unit 116 may select their corresponding passengers in a similar way, which would not be repeated herein.

Next, the processing unit 116 may assemble the selected passengers of each of the rows as the first carpool matching result. In some embodiments, the selected passengers corresponding to one of the rows could be combined as a first segment. Under this situation, the processing unit 116 may assemble the first segments corresponding to all of the rows of the carpool population matrix as the first carpool matching result.

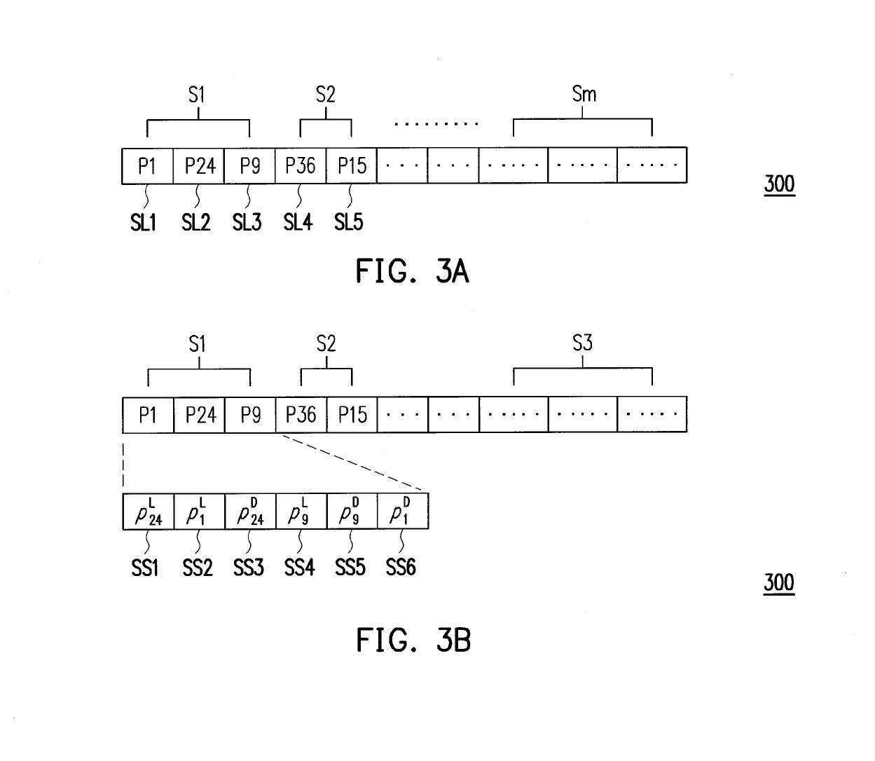

Referring to FIG. 3A, FIG. 3A is a schematic diagram illustrating a first carpool matching result according to an exemplary embodiment of the present invention. In the present embodiment, the first carpool matching result 300 includes first segments S1-Sm, which may respectively correspond to the drivers D1-Dm. As could be observed in FIG. 3A, each of the first segments S1-Sm includes some slots, which respectively correspond to a passenger. As mentioned before, each of the first segments could be regarded as a combination of the selected passengers corresponding to one of the rows. Taking the first segment S1 as an example, the first segment S1 includes slots SL1-SL3, and this represents that the driver D1 wants to provide three seats. Further, since the slots SL1-SL3 are respectively labelled by P1, P24 and P9, this may be regarded that the passengers P1, P24 and P9 are the selected passengers corresponding to the 1^{st} row of the carpool population matrix. Taking the first segment S2 as another example, the first segment S2 includes slots SL4-SL5, and this represents that the driver D2 wants to provide two seats. Further, since the slots SL4-SL5 are respectively labelled by P36 and P15, this may be regarded that the passengers P36 and P15 are the selected passengers corresponding to the 2^{nd} row of the carpool population matrix.

As for the second carpool matching result, the processing unit 116 could perform the procedure similar to the procedure of generating the first carpool matching result to generate the second carpool matching result. That is, to each of the rows of the carpool population matrix, the processing unit 116 may randomly selecting a number of the passengers according to the corresponding probabilities, wherein the number of the selected passengers is equal to a number of seats provided by the corresponding driver. Afterwards, the processing unit 116 may assemble the selected passengers of each of the rows as the second carpool matching result. In some embodiments, the selected passengers corresponding to one of the rows could be combined as a second segment. Under this situation, the processing unit 116 may assemble the second segments corresponding to all of the rows of the carpool population matrix as the second carpool matching result. Therefore, the form of the second carpool matching result would be similar to the first carpool matching result as shown in FIG. 3A.

In other embodiments, each of the first segments (or second segments) may be modified to contain routing information. Referring to FIG. 3B, FIG. 3B is a detailed illustration of the first carpool matching result illustrated in FIG. 3A. In the present embodiment, the first segment S1 could be further divided into specific slots SS1-SS6, which correspond to the order that the driver D1 picks up and drops off the passengers P1, P24 and P9. In detail, pᵢ^{L} represents that the current location of the passenger Pi, and pᵢ^{D} represents that the destination of the passenger Pi. Therefore, according to the configuration of the specific slots SS1-SS6, the driver D1 sequentially passes by the current locations of the passengers P24 and P1, the destinations of the passenger P24, the current location of the passenger P9, the destination of the passengers P9 and P1. From another point of view, the carpool server 110 hypothetically arrange the driver D1 to sequentially picks up the passengers P24 and P1, drops off the passenger P24, picks up the passenger P9 and drops off the passengers P9 and P1.

Referring back to FIG. 2, in step S230, the processing unit 116 of the carpool server 110 may perform a routing procedure to each of the first and second segments, such that a segment fitness value of each of the first and second segments is maximum.

In some embodiments, the segment fitness value of each of the first and the second segments could be characterized by a sum of the credit scores of the passengers corresponding to each of the first and the second segments or other parameters, which is not limited thereto.

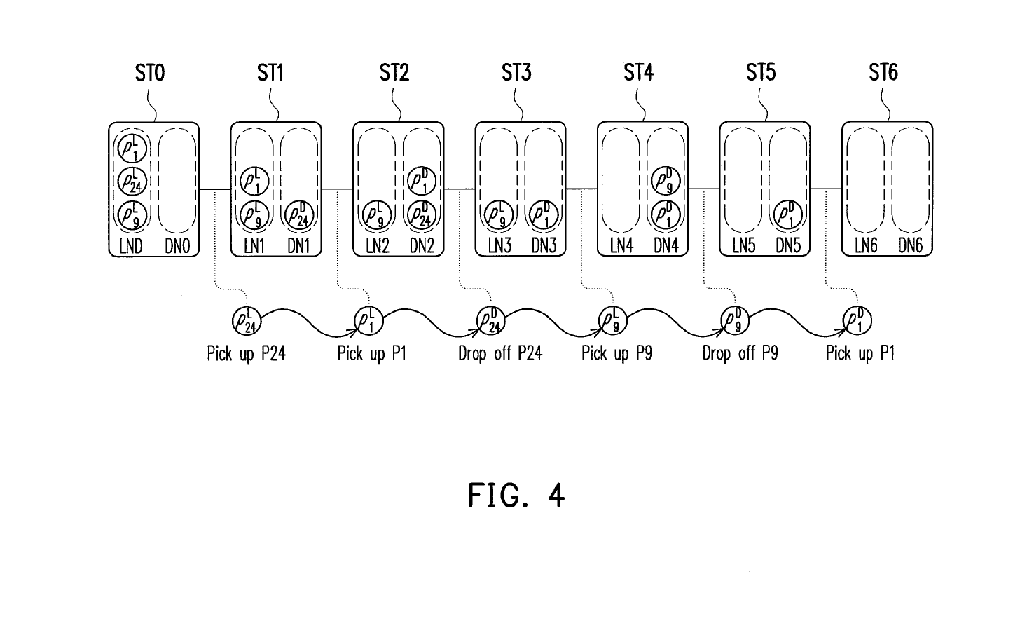

In the following embodiment, the segment fitness value of each of the first and the second segments would be discussed under the assumption of being characterized by the routing distance of each of the first and the second segments. Specifically, the shorter the routing distance is, the higher the segment fitness value is, and hence the lower the travel cost is. That is, the processing unit 116 of the carpool server 110 may find a shortest route to pick up and drop off the passengers correspond to each of the first segments, and this mechanism could be described with reference to FIG. 4.

FIG. 4 is a schematic diagram illustrating the routing procedure according to an exemplary embodiment of the present invention. In the present embodiment, the first segment S1 of FIG. 3 would be used as an illustrative example once again. Referring to FIG. 4, the routing procedure of the first segment S1 could be partitioned into stages ST0-ST6, which respectively includes a location group and a destination group. Taking the stage ST0 for example, the stage ST0 includes a location group LN0 and a destination group DN0. The location group LN0 includes elements labeled by p₁^{L}, p₂₄^{L} and p₉^{L}, which represents that the driver D1 corresponding to the first segment S1 hasn't passed by any of the current locations of the passengers P1, P24 and P9. The destination group DN0 includes no elements, which represents that the driver D1 hasn't passed by any of the destinations of the passengers P1, P24 and P9. From another point of view, the stage ST0 could be regarded as an initial stage of the routing procedure performed to the first segment S1, where the driver D1 hasn't picked up any of the passengers P1, P24 and P9.

At each of the stages ST0-ST6, the processing unit 116 of the carpool server 110 may calculate the distances between the current location of the driver D1 and the current locations of the passengers P1, P24 and P9 listed in the corresponding stage. Meanwhile, the processing unit 116 of the carpool server 110 may calculate the distances between the current location of the driver D1 and the destinations of the passengers P1, P24 and P9 listed in the corresponding stage. With the calculated distances, the driver D1 may set the next place to go as the place having the minimum distance to the current location of the driver D1.

For example, at the stage ST0, the processing unit 116 of the carpool server 110 may firstly retrieve the current location of the driver D1 (hereinafter “the driver location”), and calculate the distances between the driver location and p₁^{L}, p₂₄^{L} and p₉^{L}. Assuming the distance between the driver location and p₂₄^{L} is minimum, the processing unit 116 of the carpool server 110 may set the next place to go as the current location of the passenger P24. It should be noted that after the driver D1 arrives the current location of the passenger P24 (i.e., the driver D1 picks up the passenger P24), the processing unit 116 of the carpool server 110 should correspondingly update the driver location as p₂₄^{L}.

Proceeding to the stage ST1, it could be observed that the location group LN1 includes p₁^{L} and p₉^{L}, and the destination group DN1 includes p₂₄^{D}. That is, the driver D1 hasn't passed by the current locations of the passengers P1 and P9. However, since the passenger P24 has been picked up, the destination group DN1 may include the destination of the passenger P24 (i.e., p₂₄^{D}) . Next, the processing unit 116 of the carpool server 110 may calculate the distances between the driver location and p₁^{L}, p₉^{L} and p₂₄^{D}. Assuming the distance between the driver location and p₁^{L} is minimum, the processing unit 116 of the carpool server 110 may set the next place to go as the current location of the passenger P1.

Proceeding to the stage ST2, it could be observed that the location group LN2 includes p₉^{L}, and the destination group DN2 includes p₁^{D} and p₂₄^{D}. That is, the driver D1 hasn't passed by the current locations of the passengers P9. However, since the passenger P24 and P1 have been picked up, the destination group DN2 may include the destinations of the passenger P24 and P1 (i.e., p₁^{D} and p₂₄^{D}). Next, the processing unit 116 of the carpool server 110 may calculate the distances between the driver location and p₉^{L}, p₂₄^{D} and p₁^{D}. Assuming the distance between the driver location and p₂₄^{D} is minimum, the processing unit 116 of the carpool server 110 may set the next place to go as the destination of the passenger P24.

Since the passenger P24 has been chauffeured to his/her destination, the routing procedure does not need to consider the passenger P24 anymore. Therefore, the stage ST3 next to the stage ST2 does not contain routing information related to the passenger P24. The routing procedure of the stages ST3-ST6 could be referred to the routing procedure performed in the stages ST0-ST2, which would not be repeated herein.

After finishing the routing procedure of the first segment S1, the carpool sever 110 may transform the total routing distance related to the first segment S1 to the segment fitness value of the first segment S1.

To each of the first segments of FIG. 3A, the processing unit 116 of the carpool server 110 could perform similar routing procedures to the first segments S2-Sm, and correspondingly derive the segment fitness values of the first segments S2-Sm.

As for the second carpool matching result, the processing unit 116 may also perform the routing procedure to the second segments included in the second carpool matching result to obtain the segment fitness values of the second segments, and the related details would not be repeated herein.

Referring back to FIG. 2, in step S240, the processing unit 116 may respectively compare the segment fitness value of one of the second segments with the segment fitness value of the corresponding first segment and update the second carpool matching result by replacing the one of the second segments with the corresponding first segment if the segment fitness value of the one of the second segments is worse than the segment fitness value of the corresponding first segment.

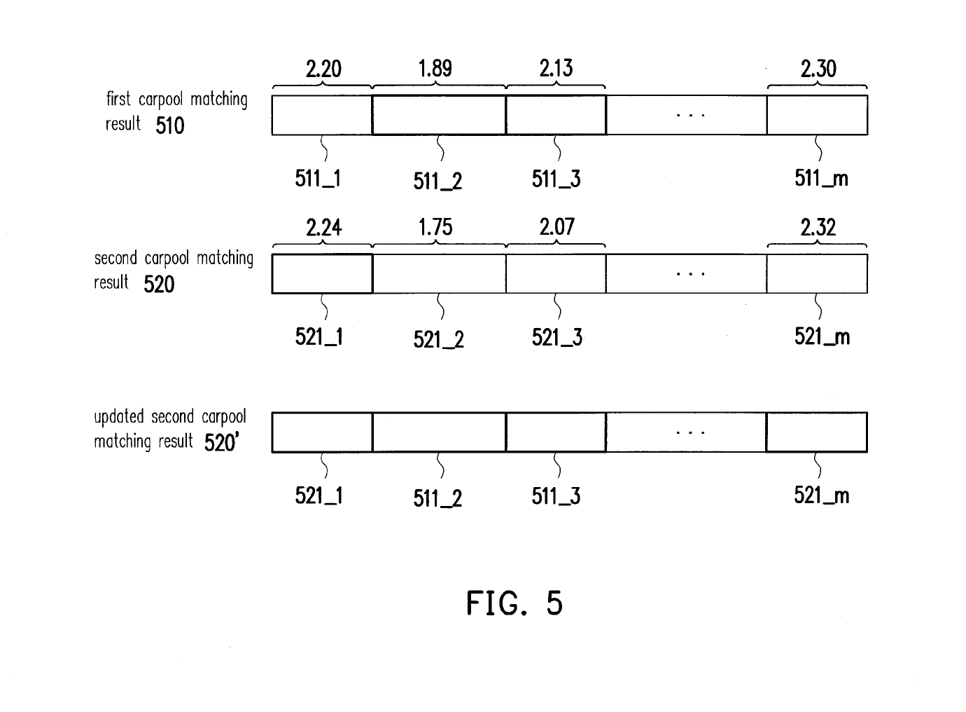

Referring to FIG. 5, FIG. 5 is a schematic diagram illustrating the mechanism of updating the second carpool matching result according to an exemplary embodiment of the present invention. In the present embodiment, it is assumed that a first carpool matching result 510 includes first segments 511_1-511_{—}m, and segment fitness values of the first segments 511_1-511_3 and 511_{—}m are respectively 2.2, 1.89, 2.13 and 2.3. Besides, it is assumed that a second carpool matching result 520 includes second segments 521_1-521_{—}m, and segment fitness values of the second segments 521_1-521_3 and 521_{—}m are respectively 2.24, 1.75, 2.07 and 2.32.

With the first carpool matching result 510 and the second carpool matching result 520, the processing unit 11 may compare the segment fitness values of one of the first segment 511_1-511_{—}m with the fitness value of the corresponding first segment. For example, the processing unit 116 may compare the fitness value of the second segment 521_1 (i.e., 2.24) with the fitness value of the first segment 511_1 (i.e., 2.20) since both of the first segment 511_1 and the second segment 521_1 correspond to the driver D1. Next, since the fitness value of the second segment 521_1 is better (i.e., higher) than the fitness value of the first segment 511_1, the processing unit 116 may maintain the second segment 521_1.

Afterwards, the processing unit 116 may compare the fitness value of the second segment 521_2 (i.e., 1.75) with the fitness value of the first segment 511_2 (i.e., 1.89) since both of the first segment 511_2 and the second segment 521_2 correspond to the driver D2. Next, since the fitness value of the second segment 521_2 is worse (i.e., lower) than the fitness value of the first segment 511_2, the processing unit 116 may update the second carpool matching result 520 by replacing the second segment 521_2 with the first segment 511_2. Similarly, the processing unit 116 may replace the second segment 521_3 with the first segment 511_3 since the segment fitness value of the second segment 521_3 is worse than the segment fitness value of the first segment 511_3. On the other hand, since the fitness value of the second segment 521_{—}m is better (i.e., higher) than the fitness value of the first segment 511_{—}m, the processing unit 116 may maintain the second segment 521_{—}m. As a result, the updated second carpool matching result 520′ could include the second segment 521_1, the first segments 511_2, 511_3 . . . and the second segment 521_{—}m.

In some embodiments, the processing unit 116 may establish another carpool matching result to record the segments included in the updated second carpool matching result 520′, instead of repeatedly updating the second carpool matching result 520, but the invention is not limited thereto.

Referring back to FIG. 2, in step S250, the processing unit 116 may update the carpool population matrix according to the updated second carpool matching result. For facilitating the following descriptions, the segments included in the updated second carpool matching result would be referred as specific segments.

In some embodiments, the processing unit 116 may update the carpool population matrix row-by-row. Specifically, to an i-th row of the rows of the carpool population matrix, the processing unit 116 may find the specific segment corresponding to the i-th row. That is, the processing unit 116 may find the specific segment that corresponds to the driver Di. Next, the processing unit 116 may retrieve the passengers included in the specific segment corresponding to the i-th row. Afterwards, the processing unit 116 may add a first parameter to the probabilities corresponding to the passengers included in the specific segment corresponding to the i-th row. Subsequently, the processing unit 116 may subtract a second parameter from the probabilities not corresponding to the passengers comprised in the specific segment corresponding to the i-th row. In some embodiments, the first parameter could be represented by ε, and the second parameter could be represented by

$$\frac{ɛ}{k - 1}$$

(where k is the total number of the passengers), but the invention is not limited thereto.

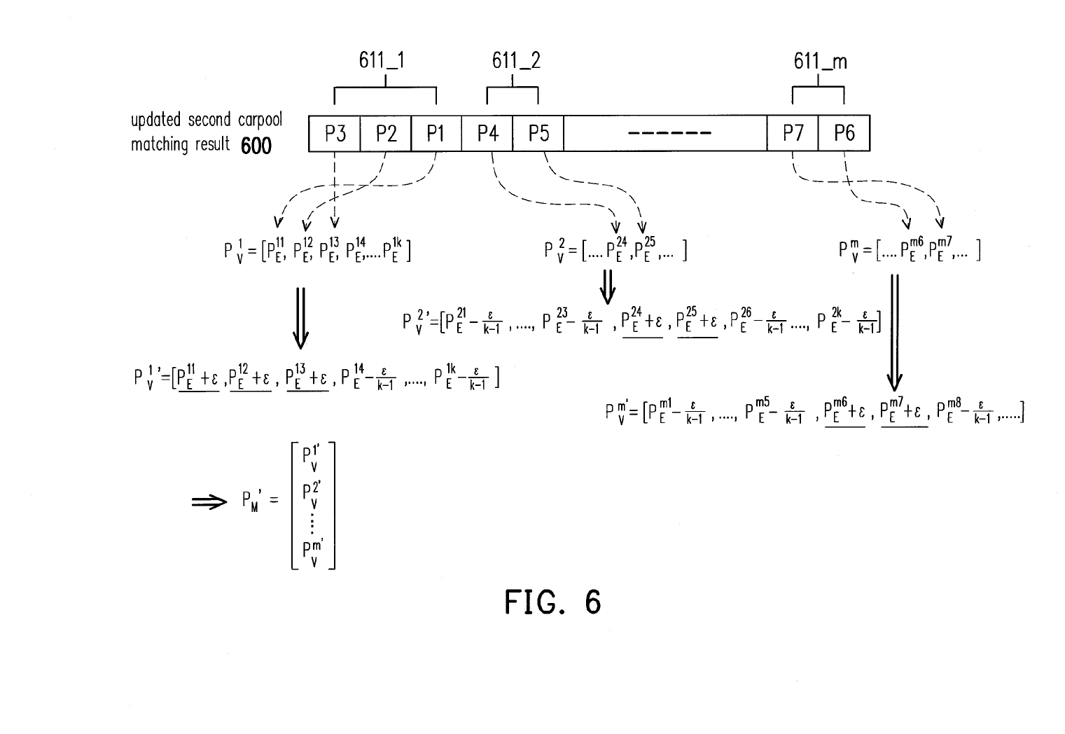

Referring to FIG. 6, FIG. 6 is a schematic diagram illustrating the mechanism for updating the carpool population matrix. In the present embodiment, an updated second carpool matching result 600 could include specific segments 611_1-611_{—}m, which correspond to the driver D1-Dm. As shown in FIG. 6, the passengers P3, P2 and P1 are assigned to the driver D1, the passengers P4 and P5 are assigned to the driver D2, and the passengers P7 and P6 are assigned to the driver Dm.

When the processing unit 116 wants to update the 1^{st} row (i.e., P_{V}¹) of the carpool population matrix, the processing unit 116 could firstly find the specific segment 611_1 since both of the 1^{st} row and the specific segment 611_1 correspond to the driver D1. Next, the processing unit 116 may retrieve the passengers P3, P2 and P1 included in the specific segment 611_1. Afterwards, the processing unit 116 may add the first parameter (i.e., ε) to the probabilities corresponding to the passengers P3, P2 and P1 (i.e., P_{E}¹³, P_{E}¹² and P_{E}¹¹). Subsequently, the processing unit 116 may subtract the second parameter (i.e.,

$$\frac{ɛ}{k - 1} )$$

from the probabilities not corresponding to the passengers P3, P2 and P1 (i.e., P_{E}¹⁴−P_{E}^{1k}). Therefore, the updated 1^{st} row (represented by P_{V}^{1′}) could be characterized by the form illustrated in FIG. 6. As mentioned before, P_{E}¹¹−P_{E}^{1k} may be regarded as the probabilities for the passengers P1-Pk to be allocated to the driver D1. Therefore, the procedure performed by the processing unit 116 could be interpreted as increasing the probabilities for the passengers P3, P2 and P1 to be allocated to the driver D1 and decreasing the probabilities for the passengers P4-Pk to be allocated to the driver D1.

When the processing unit 116 wants to update the 2^{nd} row (i.e., P_{V}²) of the carpool population matrix, the processing unit 116 could firstly find the specific segment 611_2 since both of the 2^{nd} row and the specific segment 611_2 correspond to the driver D2. Next, the processing unit 116 may retrieve the passengers P4 and P5 included in the specific segment 611_2. Afterwards, the processing unit 116 may add the first parameter (i.e., ε) to the probabilities corresponding to the passengers P4 and P5 (i.e., P_{E}²⁴ and P_{E}²⁵). Subsequently, the processing unit 116 may subtract the second parameter (i.e.,

$$\frac{ɛ}{k - 1} )$$

from the probabilities not corresponding to the passengers P4 and P5 (i.e., P_{E}²¹−P_{E}²³ and P_{E}²⁶−P_{E}^{2k}). Therefore, the updated 2^{nd} row (represented by P_{V}^{2′}) could be characterized by the form illustrated in FIG. 6. From another point of view, the procedure performed by the processing unit 116 could be interpreted as increasing the probabilities for the passengers P4 and P5 to be allocated to the driver D2 and decreasing the probabilities for the passengers P1-P3 and P6-Pk to be allocated to the driver D2.

When the processing unit 116 wants to update the m^{th} row (i.e., P_{V}^{m}) of the carpool population matrix, the processing unit 116 could firstly find the specific segment 611_{—}m since both of the m^{th} row and the specific segment 611_{—}m correspond to the driver Dm. Next, the processing unit 116 may retrieve the passengers P7 and P6 included in the specific segment 611_{—}m. Afterwards, the processing unit 116 may add the first parameter (i.e., ε) to the probabilities corresponding to the passengers P7 and P6 (i.e., P_{E}^{m7} and P_{E}^{m6}). Subsequently, the processing unit 116 may subtract the second parameter (i.e.,

$$\frac{ɛ}{k - 1} )$$

from the probabilities not corresponding to the passengers P7 and P6 (i.e., P_{E}^{m1}−P_{E}^{m5} and P_{E}^{m8}−P_{E}^{mk}). Therefore, the updated m^{th} row (represented by P_{V}^{m′}) could be characterized by the form illustrated in FIG. 6. From another point of view, the procedure performed by the processing unit 116 could be interpreted as increasing the probabilities for the passengers P6 and P7 to be allocated to the driver Dm and decreasing the probabilities for the passengers P1-P5 and P8-Pk to be allocated to the driver Dm.

After all of the rows are updated, the updated carpool matching matrix (represented by P_{M}′) could be characterized by the updated rows (i.e., P_{V}^{1′}−P_{V}^{m′}) as shown in FIG. 6.

From another point of view, since the carpool population matrix is represented by a probabilistic model instead of many individual carpool matching results, the method proposed in the present invention does not need too much memory.

In some embodiments, the processing unit 116 may further generate a new carpool matching result according to the updated carpool population matrix. The way the processing unit 116 generate the new carpool matching result is similar to the way of generating the first (or the second) carpool matching result. The difference between generating the new carpool matching result and generating the first carpool matching result is that the first carpool matching result is generated according to the carpool population matrix (i.e., P_{M}), but the new carpool matching result is generated according to the updated carpool matching matrix (i.e., P_{M}′). Therefore, to each of the rows of the updated carpool population matrix, the processing unit 116 may randomly select a number of the passengers according to the corresponding probabilities, wherein the number of the selected passengers is equal to a number of seats provided by the corresponding driver. Details could be referred to the procedure of generating the first carpool matching result, which would not be repeated herein.

Similar to the first carpool matching result, the new carpool matching result could includes segments, and for facilitating the following descriptions, the segments of the new carpool matching result could be referred as third segments.

Next, the processing unit 116 may perform the routing procedure to each of the third segments, such that the segment fitness value of each of the third segments is maximum, and the details could be referred to FIG. 4.

With the new carpool matching result and the updated second carpool result (e.g., the updated second carpool matching result 520′ of FIG. 5) the processing unit 116 may respectively compare the segment fitness value of one of the specific segments with the segment fitness value of the corresponding third segment and update the updated second carpool matching result by replacing the one of the specific segments with the corresponding third segment if the segment fitness value of the one of the specific segments is worse than the segment fitness value of the corresponding third segment. That is, the updated second carpool matching result would be updated according to the new carpool matching result again.

Next, the processing unit 116 may determine whether the updated second carpool matching result has been updated for a predetermined times. In the present embodiment, the predetermined times (e.g., 1000) could be regarded as the times that the designer wants to update the updated second carpool matching result and could be set by the designer of the carpool server 100. In some embodiments, the first parameter (i.e., ε) could be set as 1/N, where N is the predetermined times.

If the updated second carpool matching result has been updated for the predetermined times, the processing unit 116 may allocate the passengers to the drivers according to the updated second carpool matching result. For example, if the form of the updated second carpool matching result that has been updated for the predetermined times looks like the updated second carpool matching result 600 of FIG. 6, the processing unit 116 may allocate the passengers P3, P2 and P1 to the driver D1, allocate the passengers P4 and P5 to the driver D2, and allocate the passengers P7 and P6 to the driver Dm.

On the other hand, if the updated second carpool matching result has not been updated for the predetermined times, the processing unit 116 may accordingly update the updated carpool population matrix. That is, after the first and the second carpool matching result are used to firstly generate the updated second carpool matching result, this firstly updated second carpool would be used to firstly update the carpool population matrix. Next, the firstly updated second carpool population matrix would be used to generate the new carpool matching result, and this new carpool matching result would be compared with the firstly updated second carpool matching result, and hence the processing unit 116 could update the updated second carpool matching result, and so on.

Since the updated second carpool matching result is updated again and again, the travel cost of the corresponding result for allocating the passengers to the drivers would become lower and lower.

To sum up, the embodiments of the present invention provide a carpool service providing method and a carpool server using the same. By repeatedly updating the carpool population matrix according to the procedures of the method, the method proposed in the present invention could find the carpool matching result with near-optimal quality in a reasonable amount of time, such that the proposed method is applicable to real-time carpool services. That is, the total travel cost of the found carpool matching result (i.e., the actual carpool matching result) is very low, and the needed processing time is very little.

Besides, since the carpool population matrix is represented by a probabilistic model instead of being characterized by many individual carpool matching results, the method proposed in the present invention only needs a small amount of memories.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A carpool service providing method, adapted to a carpool server, comprising:
generating a carpool population matrix according to a plurality of carpool requests received from a plurality of passengers and drivers, wherein the carpool population matrix comprises a plurality of rows, each of the rows corresponds to one of the drivers, each of the rows comprises a plurality of probabilities, and each of the probabilities corresponds to one of the passengers;
generating a first carpool matching result and a second carpool matching result according to the carpool population matrix, wherein the first and the second carpool matching result respectively comprises a plurality of first and second segments corresponding to the drivers, and each of the segments comprises a plurality of slots corresponding to some of the passengers;
performing a routing procedure to each of the first and second segments, such that a segment fitness value of each of the first and second segments is maximum;
respectively comparing the segment fitness value of one of the second segments with the segment fitness value of the corresponding first segment and updating the second carpool matching result by replacing the one of the second segments with the corresponding first segment if the segment fitness value of the one of the second segments is worse than the segment fitness value of the corresponding first segment; and
updating the carpool population matrix according to the updated second carpool matching result.

2. The method as claimed in claim 1, wherein each of the probabilities is equal to a reciprocal of a number of the passengers.

3. The method as claimed in claim 2, wherein the step of generating the first carpool matching result according to the carpool population matrix comprises:
to each of the rows, randomly selecting a number of the passengers according to the corresponding probabilities, wherein the number of the selected passengers is equal to a number of seats provided by the corresponding driver; and
assembling the selected passengers of each of the rows as the first carpool matching result.

4. The method as claimed in claim 3, wherein the step of performing the routing procedure comprising:
finding a shortest route to pick up and drop off the passengers correspond to each of the segments.

5. The method as claimed in claim 4, wherein the updated second carpool matching result comprises a plurality of specific segments corresponding to the drivers, and the step of updating the carpool population matrix according to the updated second carpool matching result comprises:
to an i-th row of the rows:
finding the specific segment corresponding to the i-th row;
retrieving the passengers comprised in the specific segment corresponding to the i-th row;
adding a first parameter to the probabilities corresponding to the passengers comprised in the specific segment corresponding to the i-th row; and
subtracting a second parameter from the probabilities not corresponding to the passengers comprised in the specific segment corresponding to the i-th row.

6. The method as claimed in claim 5, wherein after the step of updating the carpool population matrix according to the updated second carpool matching result, further comprising:
generating a new carpool matching result according to the updated carpool population matrix, wherein the new carpool matching result comprises a plurality of third segments;
performing the routing procedure to each of the third segments, such that the segment fitness value of each of the third segments is maximum;
respectively comparing the segment fitness value of one of the specific segments with the segment fitness value of the corresponding third segment and updating the updated second carpool matching result by replacing the one of the specific segments with the corresponding third segment if the segment fitness value of the one of the specific segments is worse than the segment fitness value of the corresponding third segment;
determining whether the updated second carpool matching result has been updated for a predetermined times;
if yes, allocating the passengers to the drivers according to the updated second carpool matching result.

7. A carpool server, comprising:
a communication unit, configured to receive a plurality of carpool requests from a plurality of passengers and drivers;
a storage unit, configured to store a plurality of modules; and
a processing unit, coupled to the communication unit and the storage unit and configured to execute the modules to:
generate a carpool population matrix according to a plurality of carpool requests received from a plurality of passengers and drivers, wherein the carpool population matrix comprises a plurality of rows, each of the rows corresponds to one of the drivers, each of the rows comprises a plurality of probabilities, and each of the probabilities corresponds to one of the passengers;
generate a first carpool matching result and a second carpool matching result according to the carpool population matrix, wherein the first and the second carpool matching result respectively comprises a plurality of first and second segments corresponding to the drivers, and each of the segments comprises a plurality of slots corresponding to some of the passengers;
perform a routing procedure to each of the first and second segments, such that a segment fitness value of each of the first and second segments is maximum;
respectively compare the segment fitness value of one of the second segments with the segment fitness value of the corresponding first segment and update the second carpool matching result by replacing the one of the second segments with the corresponding first segment if the segment fitness value of the one of the second segments is worse than the segment fitness value of the corresponding first segment; and
update the carpool population matrix according to the updated second carpool matching result.

8. The carpool server as claimed in claim 7, wherein each of the probabilities is equal to a reciprocal of a number of the passengers.

9. The carpool server as claimed in claim 8, wherein the processing unit is configured to:
to each of the rows, randomly select a number of the passengers according to the corresponding probabilities, wherein the number of the selected passengers is equal to a number of seats provided by the corresponding driver; and
assemble the selected passengers of each of the rows as the first carpool matching result.

10. The carpool server as claimed in claim 9, wherein the processing unit is configured to:
find a shortest route to pick up and drop off the passengers correspond to each of the segments.

11. The carpool server as claimed in claim 10, wherein the updated second carpool matching result comprises a plurality of specific segments corresponding to the drivers, and the processing unit is configured to:
to an i-th row of the rows:
find the specific segment corresponding to the i-th row;
retrieve the passengers comprised in the specific segment corresponding to the i-th row;
add a first parameter to the probabilities corresponding to the passengers comprised in the specific segment corresponding to the i-throw; and
subtract a second parameter from the probabilities not corresponding to the passengers comprised in the specific segment corresponding to the i-th row.

12. The carpool server as claimed in claim 11, wherein the processing unit is further configured to:
generate a new carpool matching result according to the updated carpool population matrix, wherein the new carpool matching result comprises a plurality of third segments;
perform the routing procedure to each of the third segments, such that the segment fitness value of each of the third segments is maximum;
respectively compare the segment fitness value of one of the specific segments with the segment fitness value of the corresponding third segment and update the updated second carpool matching result by replacing the one of the specific segments with the corresponding third segment if the segment fitness value of the one of the specific segments is worse than the segment fitness value of the corresponding third segment;
determine whether the updated second carpool matching result has been updated for a predetermined times;
if yes, allocate the passengers to the drivers according to the updated second carpool matching result.
